(19) United States
(12) Patent Application Publication
(10) Pub. No.: US 2016/0240015 A1
(43) Pub. Date: Aug. 18, 2016

(54) THREE-DIMENSIONAL AVATAR GENERATING SYSTEM, DEVICE AND METHOD THEREOF

(71) Applicant: SPEED 3D Inc., Taipei City (TW)

(72) Inventors: Shiann-Tsong Tsai, Taipei City (TW); Li-Chuan Chiu, Taipei City (TW); Wei-Meen Liao, Taipei City (TW)

(21) Appl. No.: 14/953,009

(22) Filed: Nov. 26, 2015

(30) Foreign Application Priority Data
Feb. 13, 2015 (TW) 104104916

(51) Int. Cl. G06T 19/20; G06T 7/40; G06T 13/40; G06T 7/00

(52) U.S. Cl. CPC G06T 19/20; G06T 7/0042; G06T 7/40; G06T 13/40; G06T 2207/30201

(57) ABSTRACT

The invention discloses a three-dimensional avatar generating system, which comprises a server and at least one terminal device. The terminal device is communicated with the server, pre-stores an avatar substrate that may be included in an application. The server transmits a set of facial feature data and a set of facial texture data to the terminal device. The terminal device adjusts the avatar substrate according to the facial feature data and the facial texture data. The terminal device generates a three-dimensional avatar according to the facial texture data and the adjusted avatar substrate. The invention further discloses a three-dimensional avatar generating device and a three-dimensional avatar generating method as well.

### BACKGROUND OF THE INVENTION

1. Field of the Invention

The invention relates to a three-dimensional avatar generating system, device and method thereof.

2. Description of the Prior Art

Nowadays, with the difficulty for communication facility installation being reduced and the mobile terminal devices being wide used, the Internet and virtual digital contents thereof become easily access. Therefore, people spend more and more time on the web and network.

Being put in much time and affection, users increasingly attach importance to “self virtual identity management” in the Internet or virtual digital world. In conventional way, people uses characters or numbers for user description or identification, or even use photos or images for users' profile or impression production in communication media or social network. However, aforesaid manners are remained in 2D presentation and are obviously inadequate to provide a vivid avatar that acts like real person.

To resolve this problem, virtual doll or avatar technology has been developed, which typically generates three-dimensional avatars in electronic devices that simulate the face of users, or furthermore, the whole body of users. Said avatar can be built to act as a presentation of the user in the network or the virtual digital world. But in current, the application of the virtual doll or avatar technology, only allows the user to choice predesigned and stored visual modules that simulate limited numbers of facial features, face appearance, hairstyles, face shapes, or physiques, which are chosen with reference to their appearance, to create an avatar that likes user him/herself. However, too much diversity exists between people, said limited numbers of visual modules find difficulty in produce avatars that really mimic users' appearance.

Accordingly, the invention provides a three-dimensional avatar generating system, device and method thereof, which generates avatars that really mimic users' appearance by applying avatar substrates combined with user appearance relevant data. Said avatar substrate is pre-stored in user's electronic device, said user appearance relevant data is transmitted from the server, which means, the electronic don't have to carry on an avatar generating process, and process time and hardware requirement is effectively reduced. Having a three-dimensional avatar with high-similarity, the user is therefore able to act in network or virtual digital world via the presence of the avatar with high-similarity.

### SUMMARY OF THE INVENTION

An objective of the invention is to provide a three-dimensional avatar generating system, device and method thereof. With combination of an avatar substrate with user appearance relevant data, a high-similarity simulated three-dimensional avatar is generated. Due to the avatar substrate is pre-stored in user's electronic device, and a user appearance relevant data is transmitted from a server, which means, the electronic don't have to carry on an avatar generating process, and process time and hardware requirement is effectively reduced. Having a three-dimensional avatar with high-similarity, the user is therefore able to act in network or virtual digital world via the presence of the avatar with high-similarity.

In the invention, so called “head appearance” is not necessary meaning whole human head in biology or physiology. At least, the “head appearance” covers the user's face. In other word, the invention generates three-dimensional avatar that mimic the 3D facial appearance of the user, and is not limited in the appearance of limited numbers of different hairstyle or head shape for different people.

To achieve aforementioned objective, a three-dimensional avatar generating system according to the invention comprises a server and at least one terminal device. The terminal device is communicated with the server, and pre-stores an avatar substrate that may be included in an application. The server transmits a set of facial feature data and a set of facial texture data to the terminal device. The terminal device adjusts the avatar substrate according to the facial feature data and the facial texture data. The terminal device generates a three-dimensional avatar according to the facial texture data and the adjusted avatar substrate.

To achieve aforementioned objective, a three-dimensional avatar generating device according to the invention comprises: a transmission unit, a storage unit and a processing unit. The storage unit pre-stores an avatar substrate. The processing unit electronically connected with the transmission unit and the storage unit. The processing unit adjusts the avatar substrate according to the facial feature data and the facial texture data, and generates a three-dimensional avatar according to the facial texture data and the adjusted avatar substrate.

To achieve aforementioned objective, a three-dimensional avatar generating method according to the invention is applied among a server and at least one terminal device. The terminal device is communicated with the server. The three-dimensional avatar generating method comprises following steps: pre-storing an avatar substrate that may be included in an application in the terminal device; transmitting a set of facial feature data and a set of facial texture data from the server to the terminal device; adjusting the avatar substrate by the terminal device according to the facial feature data and the facial texture data; and generating a three-dimensional avatar in the terminal device according to the facial texture data and the adjusted avatar substrate.

In one embodiment, the avatar substrate is from one server.

In one embodiment, the facial feature data and the facial texture data are from one server and are obtained according to at least one planner head appearance, and the planner head appearance is corresponded with the three-dimensional avatar.

In one embodiment, the facial feature data comprises multiple facial feature points, the avatar substrate comprises at least one feature area. The feature area comprises multiple target feature points. Said multiple facial feature points is corresponding to the multiple target feature points respectively. The processing unit adjusts the spatial coordinate values of said multiple target feature points according to said multiple facial feature points.

In one embodiment, the facial texture data comprises multiple facial alignment points; the avatar substrate comprises multiple avatar substrate alignment points. Said multiple facial alignment points are corresponding to said multiple avatar substrate alignment points, respectively, such that the processing unit combines the facial texture data with avatar substrate.

In one embodiment, the processing unit changes a part of the spatial coordinate values of the avatar substrate according to the facial texture data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view of the systematic structure of an embodiment of the three-dimensional avatar generating system of the invention.

FIG. 2 is a schematic view of the terminal device illustrating an avatar substrate in the embodiment of the invention.

FIG. 3 is a schematic view illustrating the avatar substrate in FIG. 2 and marked with the feature points.

FIG. 4 is a schematic view illustrating a result that the facial feature points being fetched from the planner head appearance in the embodiment of the invention.

FIG. 5 is a schematic view of the facial texture data in the embodiment.

FIG. 6 is a schematic view illustrating the avatar substrate being adjusted according to the embodiment of the invention.

FIG. 7 is a schematic view illustrating the facial substrate combined with the avatar substrate according to the embodiment of the invention.

FIG. 8 is a flowchart of a process according to the three-dimensional avatar generating method of the embodiment of the invention.

### DETAILED DESCRIPTION

With reference to following drawings, the embodiments of the three-dimensional avatar generating system, device and method thereof in accordance with the invention is illustrated.

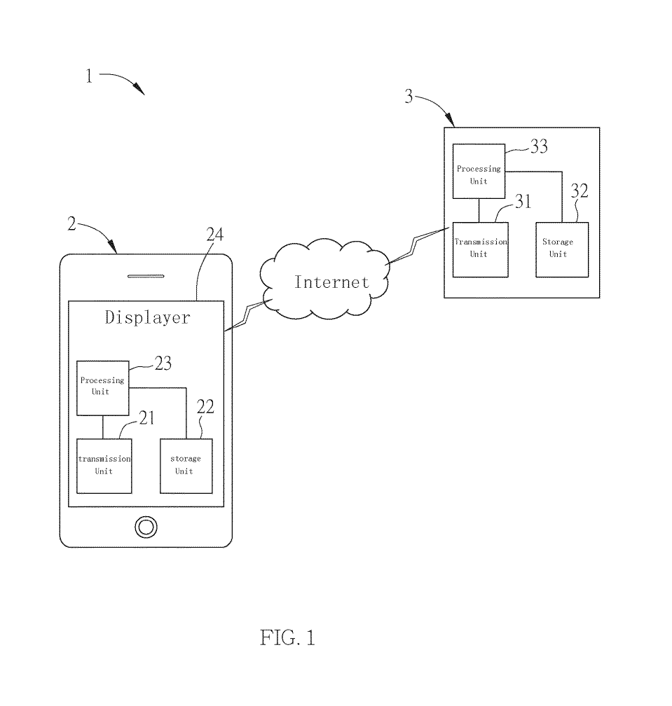

FIG. 1 is a schematic view of the systematic structure of an embodiment of the three-dimensional avatar generating system of the invention. As shown in FIG. 1, the embodiment of the three-dimensional avatar generating system 1 comprises at least one terminal device 2 and a server 3 . Preferably, multiple terminal devices 2 are comprised, such that multiple users can operate at the same time.

The terminal device 2 include but not limited to smart phone, laptop, personal digital assistant (PDA), camera with networking function, wearable devices, desktop computer, notebook computer or any other networkable devices. In this embodiment, for purposes of illustration, the terminal device 2 is a smart phone, which connects with the sever 3 via Internet, by wirelessly communication. However, in other embodiment, the terminal device 2 can be stationary notebook computers or desktop computers.

The server 3 comprises a transmission unit 31, a storage unit 32 and at least one processing unit 33. The storage unit 32 and the transmission unit 31 are connecting with the processing unit 33 respectively. In following embodiments, the server 3 performs a calculation process by the processing unit 33, and transmits data by the transmission unit 31, and stores data by the storage unit 32.

The terminal device 2 comprises a transmission unit 21, a storage unit 22, a processing unit 23 and a display unit 24. The transmission unit 21, the storage unit 22 and the display unit 24 are electronically connected with the processing unit 23 respectively.

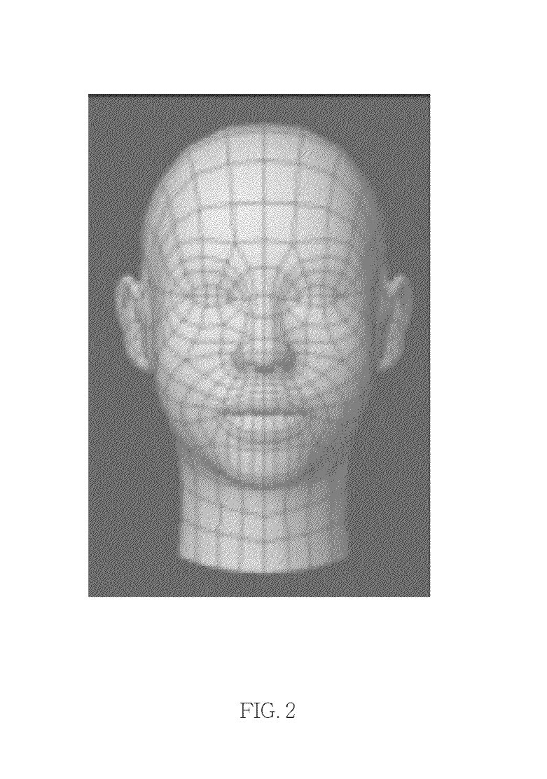

Users can use the transmission unit 21 of the terminal device 2 to download an App from the server 3 or an App stores, and installs or stores the App in the storage unit 22. In the App, an avatar substrate is comprised, so with the storing or installation of the App, the terminal device 2 contains the avatar substrate. In other word, before execution of the App, the avatar substrate is pre-stored in the storage unit 22 of the terminal device 2. The avatar substrate can be a digital 3d model with human body shape or contour, such as the contour of a face, or shape of a human body. FIG. 2 is a schematic view of the terminal device illustrating a head of an avatar substrate in the embodiment of the invention.

In this embodiment, the avatar substrate is opened in the terminal device 2, and displayed in the display unit 24 as a 3d human body image. The 3d image at least comprises a face. As shown in FIG. 2, the avatar substrate comprises a whole head, torso and limbs. The front side of the head is the face. The face is with eyebrows, eyes, ears, nose, mouth and other facial features. The avatar substrate can also be built by the server 3 downloading human data set that comprises facial features data and through the three-dimensional modeling method to achieve.

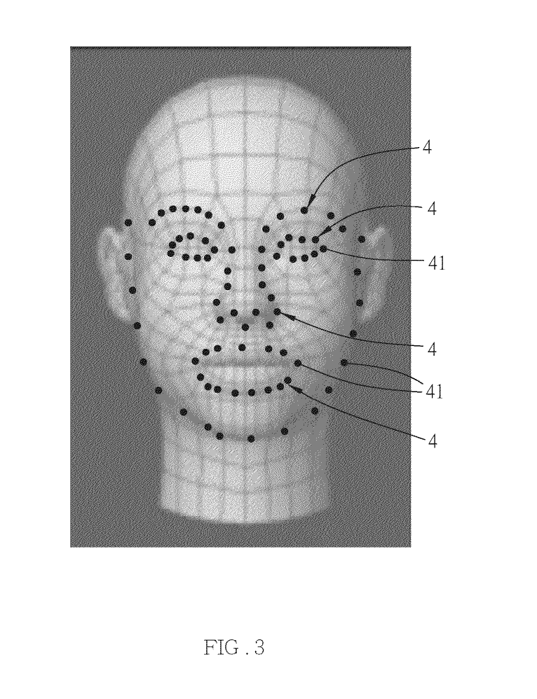

FIG. 3 is a schematic view illustrating the avatar substrate in FIG. 2 and marked with the feature points. With reference to FIG. 3, in this embodiment, when the avatar substrate is building, the eyebrows, other facial features or face shape can be defined as feature areas 4. Each feature area 4 has multiple target feature points 41. Take the eyes as example, the target feature points 41 are arranged around the eyes portion, in other word, the target feature points 41 in the eyes feature area 4 are arranged to define outlines of the eyes. Spatial coordinate values of each of the target feature points 41 are recorded in the avatar substrate respectively. Among which, the spatial coordinate values generating method can be, for example, defining the central point of the face as a reference point and thereby calculates relative spatial coordinate values of each of the target feature points 41. Besides, every target feature point 41 has a registration number of itself. In this embodiment, totally eighty-seven target feature points 41 are arranged around includes but not limited to feature area 4 like eyebrows, eyes, mouth, ears. Therefore, the numbers thereof are from one to eighty-seven, for being as identifications for each feature point. It's noticed, to avoid the drawings too complicated for illustration and understanding, in FIG. 3, eighty-seven target feature points 41 are not totally enumerated.

In FIG. 2 and FIG. 3 of present embodiment, displaying the avatar substrate by the terminal device 2 is not a necessary step for generating a three-dimensional avatar. That is, the avatar substrate need not to be displayed after stored, may be simply stored in the storage unit 22 for afterward use.

When the user hope to build a three-dimensional avatar, an App in the terminal device 2 is operated, a photo is uploaded to the server 3. The server 3 analyses the photo after receives it. In this embodiment, the user can use the terminal device 2 to take a photo with planner head appearance of his/herself, i.e. a photo with facial features, and upload it to the server 3 for analysis. Of course, in other embodiments, the user can also use photos or images that already stored in the terminal device 2 or and any storage.

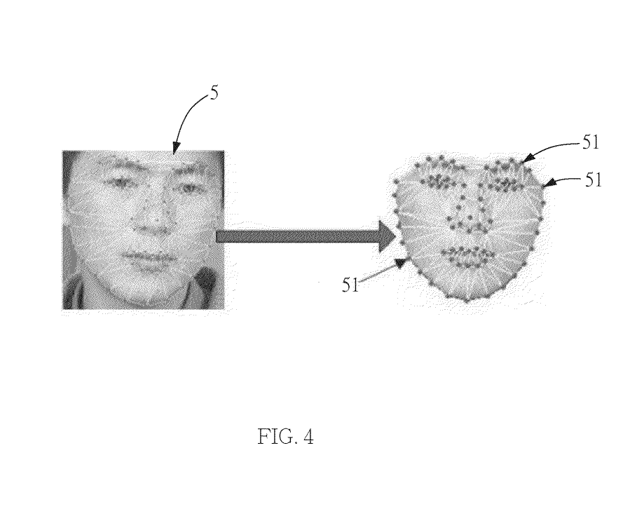

When the planner photo with user head appearance transmitted to the server 3, the processing unit 33 of the server 3 identifies the facial features in the planner head appearance by an algorithm or software program, to form a set of facial feature data. In detail, the processing unit 33 may identify the planner head appearance by visual identification relative algorithm or software program. By which, the areas containing facial features include but not limited to eyebrows, eyes, mouth, ears, nose and face shape are identified. Then, multiple points forms and defines outlines of those areas. Afterward, the server 3 fetches these points as the facial feature points, and combines these facial feature points, may with other contents, to form a set of facial feature data that comprises said facial features. FIG. 4 is a schematic view illustrating a result that the facial feature points being fetched from the planner head appearance in the embodiment of the invention. With reference to FIG. 4, in this embodiment, the planner head appearance 5 is analyzed by the algorithm of Active Appearance Model (AAM). By which, eighty-seven facial feature points 51 are obtained. The eighty-seven facial feature points 51 also have registration numbers that corresponding to the target feature points 41 of the avatar substrate, so that to facilitate an adjustment for the facial features on the avatar substrate. To avoid the drawings too complicated for illustration and understanding, in FIG. 4, eighty-seven facial feature points 51 are not totally enumerated.

Of course, to enhance the efficiency of the appearance model process algorithm, at least one set of the reference images is trained before the process begins. Otherwise, to further improve the appearance model process algorithm, during the process of fetching facial feature points 51, model data prediction and skin color range differentiated treatment in YCbCr color space are performed at the same time.

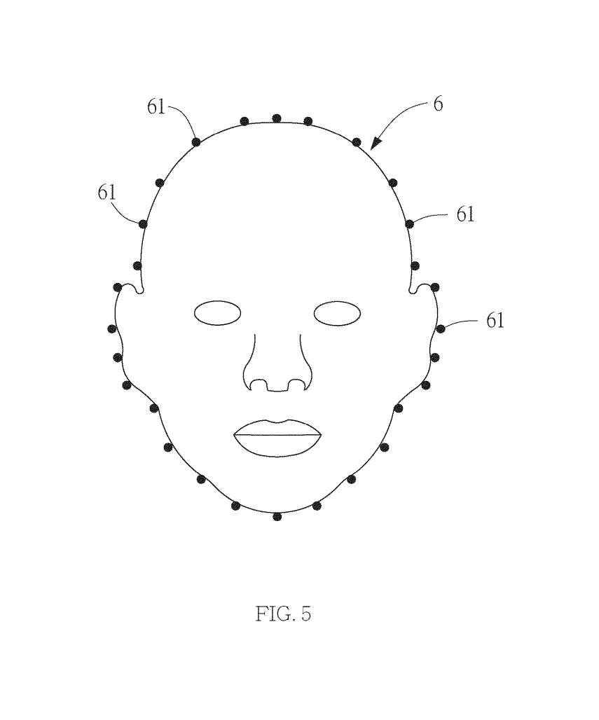

Meanwhile, an identification procedure is performed by the processing unit 33 of the server 3 according to the planner head appearance 5 in FIG. 4, to generates a set of facial texture data. The storage unit 32 of the server 3 may store lots of facial substrates. Said facial substrates may different from each other. The processing unit 33 of the server 3 may determine the geometric center of said fetched facial feature points 51 as a reference standard, to arrange the collection of the facial feature points 51 into a coordinate system, and performs a similarity calculation process upon the distance and the angle between the central position and each facial feature point 51, thereby sort out a set of the central position and each facial feature point 51 with the highest similarity from the facial texture data base. With reference to FIG. 5, which is a schematic view of the facial texture data in the embodiment.

The facial texture data 6 comprises multiple facial alignment points 61. The facial alignment points 61 are preset in each facial texture data, and the facial alignment points 61 are substantially arranged to for an outline of the facial substrate, as illustrated in FIG. 5.

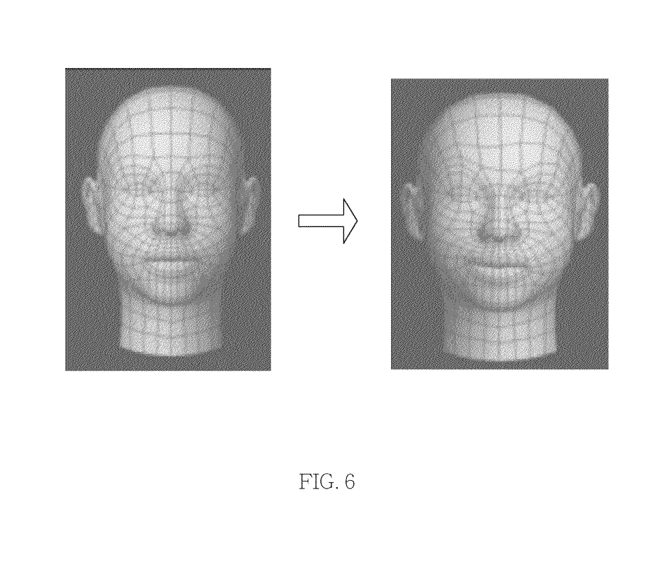

The server 3 transmits the facial feature data and the facial texture data via the transmission unit 31 to the terminal device 2. When the terminal device 2 receives those data by the transmission unit 21, the terminal device 2 processes the following steps by the processing unit 23. FIG. 6 is a schematic view illustrating the avatar substrate being adjusted according to the embodiment of the invention. With reference to FIG. 6, first, the processing unit 23 utilizes the registration number relationship between the facial feature points 51 of the facial feature data and the target feature points 41 of the avatar substrate, and according to the spatial coordinate values of each facial feature points 51, respectively amends the spatial coordinate values of each target feature points 41. The result may change an arrangement of the target feature points 41, therefore change the position of displayed pixels for the avatar substrate. Thereby the facial area of the avatar substrate, include but not limited to eyebrows, eyes, ears, nose, mouth and other facial features, which are similar to the facial area of the planner head appearance 5. In a style of this embodiment, the processing unit 23 calculates the registration numbers of the facial feature points 51 and the differences between the spatial coordinate values of the target feature points 41 in advance, then uses the neural network software system like Radial basis function (RBF) network to calculate the differences and correct the avatar substrate, so as to allow the avatar substrate has a facial appearance that is similar to the planner head appearance 5.

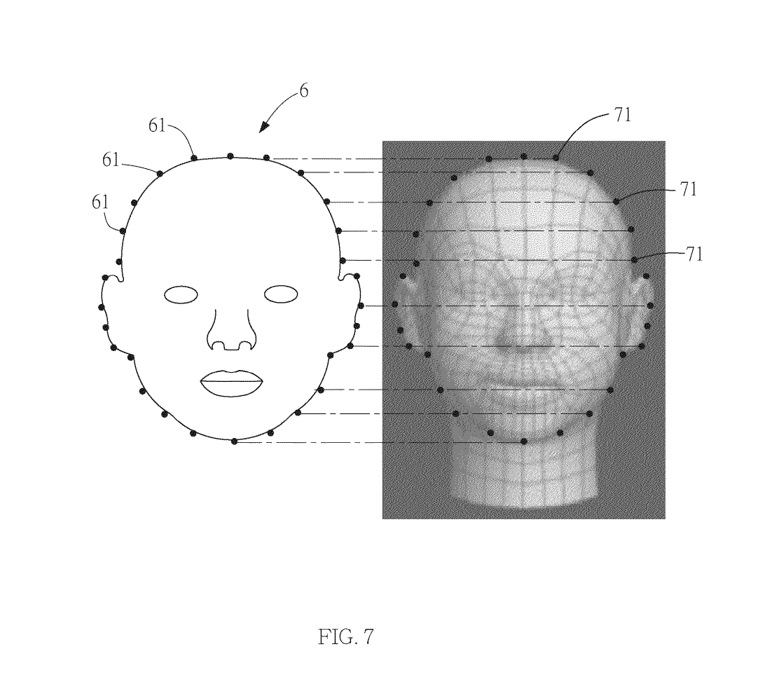

FIG. 7 is a schematic view illustrating the facial substrate combined with the avatar substrate according to the embodiment of the invention. With further reference to FIG. 7 and FIG. 3, since each of the facial alignment points 61 has a registration number itself, and the avatar substrate stored in the terminal device 2 also have avatar substrate alignment points 71 and registration numbers, the processing unit 23 may combine the facial substrate with the avatar substrate according to an relationship between the registration numbers of the alignment points among which. Aforementioned steps is like to “paste a face skin” onto the avatar substrate, i.e. pick out a facial substrate with facial features similar to the planner head appearance 5 and paste it onto the avatar substrate, to provide an avatar substrate with facial features of the planner head appearance 5, said facial features includes but not limited to face breadth or chin protrusion.

However, since the facial area of the avatar substrate is in a predetermined standard face size, a difference should be existing as the facial substrate combining with the avatar substrate. For example, if the planner head appearance 5 is a narrow face with pointed chin, and the facial substrate is a narrow face with pointed chin as well, when this facial substrate paste onto the avatar substrate, a relative protrusion occurs on the cheeks portion of the avatar substrate, and relative gaps occurs between the chin portions of the facial substrate and the avatar substrate. Such, the processing unit 23 should have to adjust the avatar substrate alignment points 71 of the avatar substrate according to the facial alignment points 61 of the facial substrate. In this embodiment, the adjustment of the processing unit 23 is to change the spatial coordinate values of the avatar substrate alignment points 71, thereby changes the position of the displayed pixels of the avatar substrate. In such way, when the facial substrate and the avatar substrate displayed together, mentioned protrusion or gaps is accordingly not existing. By adjusting the spatial coordinate values of the avatar substrate alignment points 71, the avatar substrate alignment points 71 move toward to or away from a central position of the coordinate system, which illustrated as partial decrement or increment on the avatar substrate.

After that, the processing unit 23 displays the adjusted avatar substrate that according to the facial feature data and facial texture data, and the facial texture data on the display unit 24, to generate a three-dimensional avatar corresponding to the planner head appearance 5. Furthermore, in the displayed three-dimensional avatar, eyebrows, eyes, ears, nose, mouth and other facial features are formed from the facial feature data of the adjusted avatar substrate, the face-covering “face skin” is formed from the facial texture data. In the displayed three-dimensional avatar, the processing unit 23 may further combine an adjusted avatar substrate with a set of facial texture data, to display the combined set of data. However, the processing unit 23 can also display two sets of data, and displays them at suitable positions according to the alignment points. The invention, however, is not limited thereto.

Of course, aforesaid steps of the adjusted avatar substrate are not fixed in sequence of execution, it can also be adjusting the avatar substrate face by the facial texture data, then adjusting the eyebrows, eyes, ears, nose, mouth and other facial features of the avatar substrate by the facial feature data.

In other embodiments of the invention, the avatar substrate can only has an upper body, head and even face, depends on user's demand.

In other embodiments of the invention, the processing unit 23 of the terminal device 2 further performs a picture mapping step after the three-dimensional avatar is generated, so as to allow decorations like a hair, glasses, beard or cloth costumes be formed on the three-dimensional avatar. Said picture mapping process can also be performed by assistance of the alignment points. Specifically, the three-dimensional avatar may have hair alignment points, and a selected hair module may have alignment points corresponding thereto. To combine said alignment points, i.e. to equal the spatial coordinate values of those alignment points, the hair module can be combined with the three-dimensional avatar. Of course, mapping of other pictures like glasses, beard is the same with aforementioned process.

In other embodiments of the invention, the generated three-dimensional avatar may be combined with predetermined background, so as to simulate the user avatar in a predetermined location or environment. Otherwise, the data of the three-dimensional avatar can be used for 3D printing process to obtain a printed doll. Moreover, the three-dimensional avatar can also be used for making electronic cards or stickers. The invention, however, is not limited thereto.

Further, in other embodiments of the invention, after the planner head appearance uploaded to the server, the server performs a noise reduction or skin beautifier process upon the planner head appearance, so as to facilitate following identification steps, or optimize effects of the generated three-dimensional avatar.

The invention further discloses a three-dimensional avatar generating device. The three-dimensional avatar generating device comprises a transmission unit, a storage unit and a processing unit. The storage unit pre-stores an avatar substrate. The processing unit electronically connected with the transmission unit and the storage unit respectively. The processing unit adjusts the avatar substrate according to the facial feature data and the facial texture data, and generates a three-dimensional avatar according to the facial texture data and the adjusted avatar substrate. However, the technical content and process steps for the three-dimensional avatar generating device is like with aforementioned terminal device of the three-dimensional avatar system, please refer to the foregoing, omitted herein.

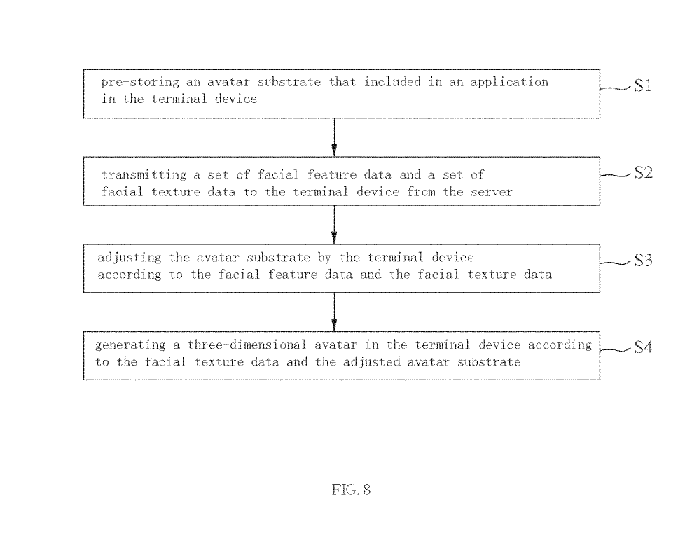

FIG. 8 is a flowchart of a process according to the three-dimensional avatar generating method of the embodiment of the invention. With reference to FIG. 8, the invention further discloses a three-dimensional avatar generating method. The three-dimensional avatar generating method is applied among a server and at least one terminal device communicated with the server. The three-dimensional avatar generating method, which is applied among a server and at least one terminal device communicated with the server, the three-dimensional avatar generating method comprises following steps:

pre-storing an avatar substrate that included in an application in the terminal device (S1);

transmitting a set of facial feature data and a set of facial texture data to the terminal device from the server (S2);

adjusting the avatar substrate by the terminal device according to the facial feature data and the facial texture data (S3); and

generating a three-dimensional avatar in the terminal device according to the facial texture data and the adjusted avatar substrate (S4). However, the technical content and process steps for the three-dimensional avatar generating method is like with aforementioned three-dimensional avatar generating system, please refer to the foregoing, omitted herein.

In summary, the use of remote or cloud processing to generate a three-dimensional avatar will be faced with difficulties while made large amount of data transmission, which resulting in transmission speed slow problem. With according to the invention, the three-dimensional avatar generating system, device and method thereof, by pre-storing an avatar substrate in the terminal device and receiving the facial feature data and facial texture data for adjusting and generating a three-dimensional avatar, effectively avoids a huge volume of data transmission and therefore increases the avatar generating efficiency. Furthermore, the invention balances the local hardware resources while them are insufficient to processing massive data at high speed, and resolves the problem of too huge data transmission remotely or via the cloud, allowing avatar or doll can be more readily applied in different aspects.

Comparing with the conventional way that solely performs the three-dimensional avatar generating process on a terminal device or server, the invention provide a flexible way to optimally utilize the hardware resources. Otherwise, since users are used to spend more time to waiting for APP installation, which simultaneously pre-stores an avatar substrate, in viewpoint of user experience optimization, the invention provide a better solution avoiding time-consuming loading of avatar substrate for multiple times.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1, a three-dimensional avatar generating device, comprises:
a transmission unit;
a storage unit pre-storing an avatar substrate; and
a processing unit electronically connecting to the transmission unit and the storage unit;
wherein the transmission unit receives a set of facial feature data and a set of facial texture data, the processing unit adjusts the avatar substrate according to the facial feature data and the facial texture data, and generates a three-dimensional avatar according to the facial texture data and the adjusted avatar substrate.

2, The three-dimensional avatar generating device as claimed in claim 1, wherein the avatar substrate is provided by a server.

3, The three-dimensional avatar generating device as claimed in claim 1, wherein the facial feature data and the facial texture data are transmitted from a server and are obtained according to a planner head appearance corresponding to the three-dimensional avatar.

4, The three-dimensional avatar generating device as claimed in claim 1, wherein:
the facial feature data comprises multiple facial feature points;
the avatar substrate comprises at least one feature area having multiple target feature points;
the multiple facial feature points corresponds to the multiple target feature points respectively; and
the processing unit adjusts spatial coordinate values of said multiple target feature points according to the multiple facial feature points.

5, The three-dimensional avatar generating device as claimed in claim 1, wherein:
the facial texture data comprises multiple facial alignment points, and the avatar substrate comprises multiple avatar substrate alignment points, said multiple facial alignment points being corresponding to said multiple avatar substrate alignment points respectively, such that the processing unit combines the facial texture data with the avatar substrate.

6, A three-dimensional avatar generating system, comprises:
a server; and
at least one terminal device communicated with the server and pre-storing an avatar substrate that included in an application;
wherein the server transmits a set of facial feature data and a set of facial texture data to the terminal device; the terminal device adjusts the avatar substrate according to the facial feature data and the facial texture data, and generates a three-dimensional avatar according to the facial texture data and the adjusted avatar substrate.

7, The three-dimensional avatar generating system as claimed in claim 6, wherein the facial feature data and the facial texture data are transmitted from a server and are obtained according to a planner head appearance corresponding to the three-dimensional avatar.

8, The three-dimensional avatar generating system as claimed in claim 6, wherein the facial feature data comprises multiple facial feature points; the avatar substrate comprises at least one feature area having multiple target feature points; wherein said multiple facial feature points corresponds to said multiple target feature points respectively; and the terminal device adjusts spatial coordinate values of the multiple target feature points according to the multiple facial feature points.

9, The three-dimensional avatar generating system as claimed in claim 6, wherein the facial texture data comprises multiple facial alignment points; the avatar substrate comprises multiple avatar substrate alignment points; wherein said multiple facial alignment points corresponds to said multiple avatar substrate alignment points respectively; thereby the terminal device combines the facial texture data with the avatar substrate.

10, A three-dimensional avatar generating method, which is applied among a server and at least one terminal device communicated with the server, the three-dimensional avatar generating method comprises following steps:
pre-storing an avatar substrate that included in an application in the terminal device;
transmitting a set of facial feature data and a set of facial texture data to the terminal device from the server;
adjusting the avatar substrate by the terminal device according to the facial feature data and the facial texture data; and
generating a three-dimensional avatar in the terminal device according to the facial texture data and the adjusted avatar substrate.
